(19) United States
(12) Patent Application Publication
(10) Pub. No.: US 2014/0214640 A1
(43) Pub. Date: Jul. 31, 2014

(54) PARENTAL MANAGEMENT OF DIGITAL ASSETS

(71) Applicant: APPLE INC., Cupertino, CA (US)

(72) Inventors: Raghuveer Mallikarjunan, Sunnyvale, CA (US); Wael S. Barakat, San Jose, CA (US)

(73) Assignee: Apple Inc., Cupertino, CA (US)

(21) Appl. No.: 13/753,185

(22) Filed: Jan. 29, 2013

(51) Int. Cl. G06Q 20/36

(52) U.S. Cl. CPC G06Q 20/36
USPC 705/35

(57) ABSTRACT

Disclosed are systems, methods, and non-transitory computer-readable storage media for transferring assets and monitoring spending activity of dependents. A digital wallet processing engine receiving a request from a parent to enable a Parent Mode and link the parent's digital wallet account with a dependent's digital wallet account in a network-based storage platform and to transfer assets to the dependent's account, monitor the dependent's account, and otherwise manage the dependent's account.

### BACKGROUND

1. Technical Field

The present disclosure relates to transferring assets and more particularly to parental transfers of digital assets to dependents.

2. Introduction

With the growth of the popularity of consumer electronics, many consumers prefer to consolidate items of commerce into digital forms. However, current systems for making payments are insufficiently suited for integration with a digital experience using modern consumer electronic devices. Additionally, existing systems for transferring transactional instruments between users are lacking with respect digital integration, adoption, and convenience.

As electronic device usage grows among children, parents have a harder job of managing what their children have access to on those devices. Digital wallet applications allow users to manage their own tickets, passes and gift cards with one single interface. However, known methods of transferring those digital assets to children are lacking.

Additionally, there are many scenarios where a parent may want to send his kids to a movie or to shop at a particular store. However, simply providing children with cash and trusting they will use it as agreed upon is not always a good option. For example, the child might lose the money, have the money stolen from them, use the money for some other purpose that the parents do not approve of, etc. Consequently, there is a need for systems, computer-readable media, and methods for transferring digital assets to dependents and monitoring the dependent's activity with respect to the digital assets.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for transferring assets and monitoring spending activity of dependents.

Some embodiments of the present technology involve a digital wallet processing engine receiving a request from a parent to enable a Parent Mode and link the parent's digital wallet account with a dependent's digital wallet account in a network-based storage platform and to transfer assets to the dependent's account, monitor the dependent's account, and otherwise manage the dependent's account. The request can be forwarded to the dependent and upon receiving consent from the dependent, the digital wallet processing engine can link the dependent's account with the parent's account.

In some embodiments of the present technology, linking the dependent's account with the parent's account in the network-based storage platform involve creating a shared workspace in the network-based storage platform accessible by parent and the dependent. The parent can then transfer digital cards and digital assets to the shared workspace and the dependent can access the transferred assets while the parent maintains control.

In some embodiments, the parent is given a management interface accessible through the parent's digital wallet account or a media distribution platform client application. The interface can include tools for managing the dependent's digital wallet account. Some embodiments of the present technology involve updating the interface in real time to reflect changes in the dependent's digital wallet account to allow the parent to track the dependent's activity.

Some embodiments involve pushing notifications from the network-based storage platform to an electronic device of the parent and pushing notifications relating to the request from the network-based storage platform to an electronic device of the dependent.

### BRIEF DESCRIPTION OF THE DRAWINGS

In order to describe the manner in which the above recited and other advantages and features of the disclosure can be obtained, a more particular description of the principles briefly described above will be rendered by reference to specific embodiments thereof that are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates exemplary application interface for carrying out transactions using digital cards in a digital wallet;

FIG. 2 illustrates an exemplary system for tracking asset transfers according to the present technology;

FIG. 3 illustrates two exemplary Graphical User Interfaces (GUI) for enabling a Parent Mode that allows the transfer and management of assets in a digital wallet application;

FIG. 4 illustrates a method of setting up Parent Mode in a digital wallet application according to some embodiments of the present technology;

FIG. 5 illustrates a method of a parent purchasing digital assets and transferring the digital assets to a dependent in the form of a digital card according to some embodiments of the present technology;

FIG. 6 illustrates an exemplary method of a parent monitoring a dependent's digital assets;

FIG. 7 illustrates an exemplary activity-tracking interface;

FIG. 8 illustrates an exemplary event notification directed to a parent running a parent mode in a digital wallet application;

FIG. 9 illustrates an exemplary event notification directed to a parent running a parent mode in a digital wallet application; and

FIG. 10 illustrates an exemplary general-purpose computing device.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosure addresses the need in the art for more sophisticated systems, methods, and computer-readable media for transferring assets and monitoring spending activity of dependents. In order to ensure that children use assets for their intended purpose, the present technology involves transferring digital cards and digital assets to dependent devices. Such transfers can include tickets to a specific movie, a gift card for a particular store, a gift card with restrictions placed on its use, daily digital asset allowances, etc.

Some embodiments of the present technology involve a digital wallet application for transferring assets from one digital card to another digital card. One example of a digital wallet application is PASSBOOK, available from Apple Inc. of Cupertino, Calif.

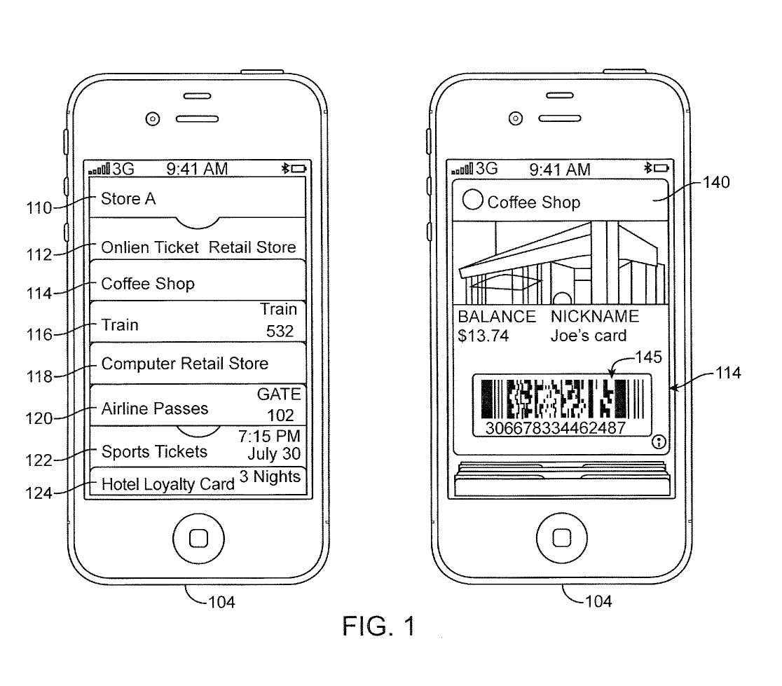

FIG. 1 illustrates exemplary application interface for carrying out transactions using digital cards in a digital wallet. As shown in FIG. 1, a computing device 104 runs an application for displaying a digital wallet interface comprising a plurality of digital cards 110, 112, 114, 116, 118, 120, 122, 124 in a wallet configuration. The digital cards can include digital representations of merchant-specific prepaid account cards, merchant-specific credit cards, all-purpose credit cards, airline boarding passes, other transportation tickets, movie tickets, sporting event tickets, gift cards, loyalty cards, mobile coupons, identification cards, bank and debit cards, etc. Likewise, the digital cards can be associated with user accounts, online profiles, financial accounts, retail store accounts, loyalty accounts, coupon subscription accounts, etc.

The wallet configuration can include a vertical stack of digital cards with only a small part of the digital card being visible. In some embodiments, the visible portion of the digital cards 110, 112, 114, 116, 118, 120, 122, 124 provides information about the card. For example, in the wallet configuration, the visible part of digital card 110 displays information relating to a retail store that the digital card 110 is issued from. In another example, in the wallet configuration, the visible part of digital card 120 displays the name of an airline and information about an upcoming flight.

The digital cards 110, 112, 114, 116, 118, 120, 122, 124 can be interactive such that hovering over a card with an input method such as a mouse cursor or a single finger placement on a touch screen causes the computing device 104 to display a thumbnail view of a detailed card interface Likewise, selecting a digital card with a mouse click or single finger tap on a touch screen causes the computing device 104 to display a full detailed card interface 140.

In some embodiments of the disclosure, a detailed card interface 140 provides additional information about the digital card, the account associated with the digital card, or both. Additionally, the detailed card interface 140 can display an optical code 145 for effecting a financial transaction. Also, a detailed card interface 140′ can display an optical code 145′ used to provide entrance in a gatekeeping application. As discussed below, a digital card interface can include an interface for transferring assets.

In some embodiments, one or more of the digital cards 110, 112, 114, 116, 118, 120, 122, 124 can provide notifications through the computing device 104 relating to an event. For example, according to FIG. 1, an application can associate an airline reservation system with digital card 120 to update the computing device with changes to air travel and to provide the user of the computing device 104 with one or more notifications 150 relating to a flight itinerary. As discussed below, some embodiments of the disclosure involve receiving notifications relating to digital card asset transfer requests.

A digital wallet application can provide great convenience to users by centralizing all of a user's retail card accounts, travel accounts, loyalty program accounts, etc. such that the user can open a single application to access any of his/her accounts by tapping on a card. Also, digital cards can replace the need to carry cash or credit cards when a user has merchant-specific prepaid digital cards. Additionally, some embodiments of the disclosure also involve systems, methods, and computer readable media for providing digital wallet applications the ability to transfer assets from an account associated with digital card to another, transfer assets between a first client device and another client device, or both transfer between accounts and transfer between devices.

Some examples of assets include cash, credit, reward points, airline frequent flyer points, coupons, loyalty points, promotions, gatekeeper passes, etc. Although some specific examples of assets are disclosed explicitly herein, those with ordinary skill in the art having the benefit of this disclosure will readily understand that any type of transferrable asset can benefit from the disclosure.

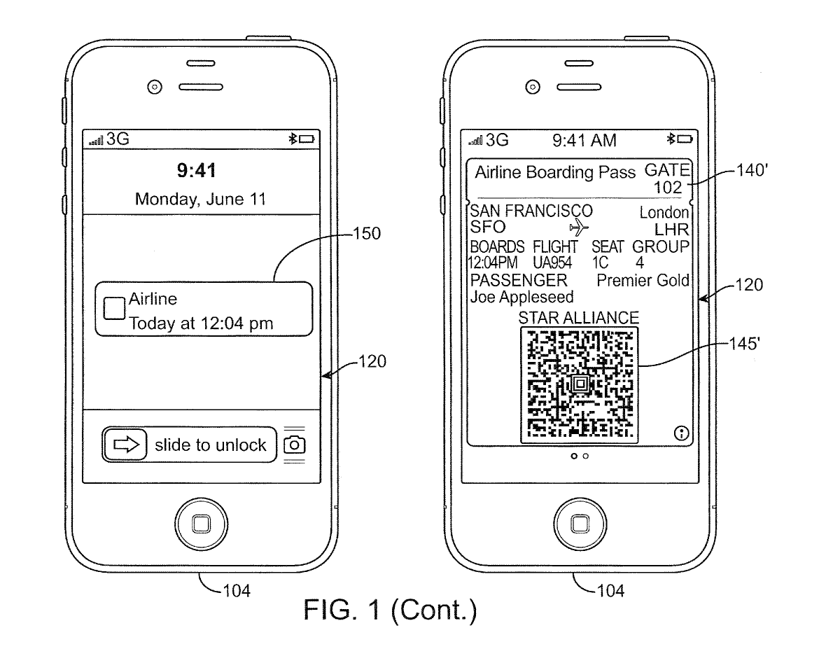

Some embodiments of the disclosure involve a system configured to facilitate various types of asset transfers and configured to monitor and manage asset transfers between a plurality of client devices. FIG. 2 illustrates an exemplary system 200 for tracking asset transfers according to the present technology.

The system 200 discussed herein allows a user to enable a “Parent Mode” in a digital wallet application which allows a user to transfer assets to another user while maintaining auditing capability and while maintaining a managing role in controlling how the assets are used by the receiving user. Oftentimes, the transferor is a parent and the transferee is a dependent child; however, those with ordinary skill in the art having the benefit of this disclosure will readily appreciate that the novel features of the present technology can be extended to a wide variety of asset transfer scenarios between any types of users. Accordingly, while the terms parent, dependent, and child are sometimes used to describe a transferor-transferee relationship, they are used to be illustrative only and not to imply that other parties cannot benefit from the present technology.

The system 200 of FIG. 2 includes a parent device 210 operatively coupled with a digital wallet platform 260 via a network 220. The digital wallet platform 260 is also operatively coupled with collection 280 of dependent devices D₁, D₂, D₃, . . . , Dₙ via a network 270. Networks 220 and 270 can comprise any type of communication network, now known or later developed, and can comprise the same network or different networks.

The digital wallet platform 260 includes a digital wallet engine 230 comprising one or more processing modules for executing digital wallet applications and processes. For example, the digital wallet engine 230 can be configured to display digital cards on a client device and receive input from a user of the client device as discussed in FIG. 1.

The digital wallet platform 260 also includes an account database 250 configured to store user account information and user financial account information for a plurality of users. For example, in some embodiments of the present technology, the account database 250 stores a user's account name that is used in a media distribution platform, such as ITUNES, available from Apple Inc. of Cupertino, Calif. Likewise, the account database 250 can store user financial account information associated with the media distribution platform, such as the user's credit card number or banking account information. Likewise, as will be explained in more detail below, the digital wallet platform can also be tied to a network-based storage platform 290, such as ICLOUD, available from Apple Inc. of Cupertino, Calif.

The digital wallet platform 260 also includes a parent mode module 240 configured to facilitate asset transfers between digital wallet accounts and financial accounts, and configured to manage and track asset transfers using the digital wallet applications on the parent device 210 and the collection 280 of dependent devices.

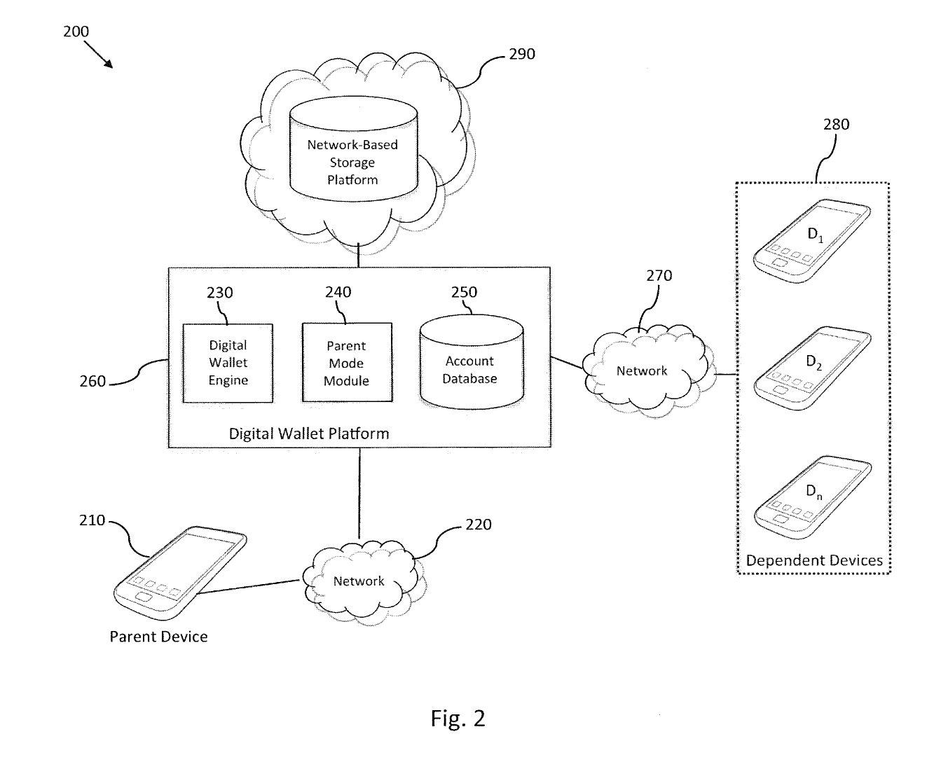

A user can enable Parent Mode to transfer assets and manage transferred assets in a number of ways. For example, a user can enable Parent Mode through a digital wallet application settings menu or through a media distribution platform client application. FIG. 3 illustrates two exemplary Graphical User Interfaces (GUI) 300, 350 for enabling a Parent Mode that allows the transfer and management of assets in a digital wallet application.

The GUI 350 illustrated in FIG. 3 allows a user to turn on a Parent Mode through a digital wallet application settings interface 360 in a settings menu 370 of a network-based storage platform. As shown in FIG. 3, the settings interface 360 includes buttons 380 and 390. Button 380 enables tracking of a parent's own digital cards or passes through a network-based storage platform interface. Button 390 turns on Parent Mode. In some embodiments, turning on Parent Mode brings up another interface that allows a parent to add new dependents, manage a dependent's digital cards, transfer assets to a dependent's digital cards, transfer new digital cards to a dependent, track a dependent's activity, remove digital cards from a dependent, etc.

Additionally, as explained above, some embodiments of the present technology involve asset transfers between user accounts tied to a media distribution platform. According to FIG. 3, a media distribution platform client application GUI 300 includes “Parent Mode” frame 310 containing information about a user's dependents. The GUI includes an “Add Dependent” tool 320 to request consent from additional dependents to allow the parent to manage their digital assets. The GUI also lists dependents 330, 335 who have already given consent on whom the parent can monitor and manage their digital assets. Likewise, the GUI includes collections of links 340, 345 for managing the dependents' digital assets.

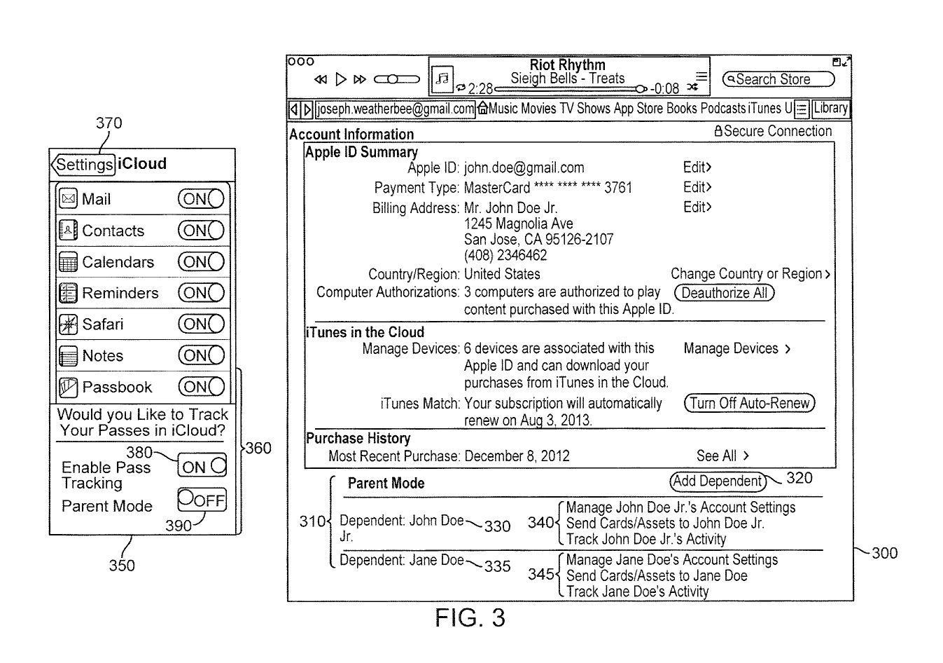

FIG. 4 illustrates a method 400 of setting up Parent Mode in a digital wallet application according to some embodiments of the present technology. The method 400 involves the user of a client device enabling Parent Mode on the device 410. In some embodiments of the present technology, the parent user enters Parent Mode via a media distribution platform interface such as ITUNES client installed on a computer. In some embodiments, the parent user enters Parent Mode via a digital wallet application, such as PASSBOOK. Upon entering Parent Mode, the parent user inputs one or more account identifiers for his dependents 420. In some embodiments, the parent user can enter an account name used in a media distribution system or a digital wallet application to identify his dependents. In some embodiments, the parent user enters his dependents' phone numbers, email addresses or other identifying information and a media distribution system or digital wallet application looks up the account information based on the email address or other information.

Next, a request is sent to a dependent's device 430. In some cases, the request appears upon the dependent signing into a media distribution platform client interface or a digital wallet application. In some embodiments, the request is sent as a notification, as explained in more detail below. In some embodiments, the request involves asking for consent to be listed as a dependent, consent to be linked with a parent account, and consent to have an account monitored and managed. In some embodiments, the request involves conditional options such that the dependent can provide consent to the parent to be listed as a dependent and for the parent to perform some monitoring options, but not others—for example.

Next, the dependent sends request approval or conditional approval 440 and the dependent account is linked with the parent account and controls are provided to the parent 450. Linking a parent account with a dependent's account allows the parent to control the dependent's account 460 by overseeing activity and manage a dependent's digital assets in a digital wallet application.

In some embodiments of the present technology, the link between the parent and the dependent is memorialized in the account database 250 of the digital wallet platform 260. Consequently, in some embodiments, the dependent's consent to allow the parent to manage their digital cards cannot be withdrawn after receiving the transferred digital assets. Saving the link between parent and dependent also avoids having to ask for consent each time the parent wants to interact with a dependent's digital wallet.

As explained above with respect to GUI 350, in some embodiments, the link between accounts is made in a settings menu of a network-based storage platform client application. In these embodiments, the link memorialized in the digital wallet platform also links network-based storage platform accounts. For example, linking a parent's ITUNES account with a child's account also links their ICLOUD accounts. Indeed, linking network-based storage platform accounts can also create a shared network-based platform workspace enabling multi-party access to the same digital cards and digital assets.

Various types of transfers can be made using the digital wallet platform 260. For example, a parent can transfer a digital card preloaded with assets to a dependent if the dependent does not already have that digital card. Additionally, a parent can also transfer supplemental assets to a digital card already associated with the dependent's device.

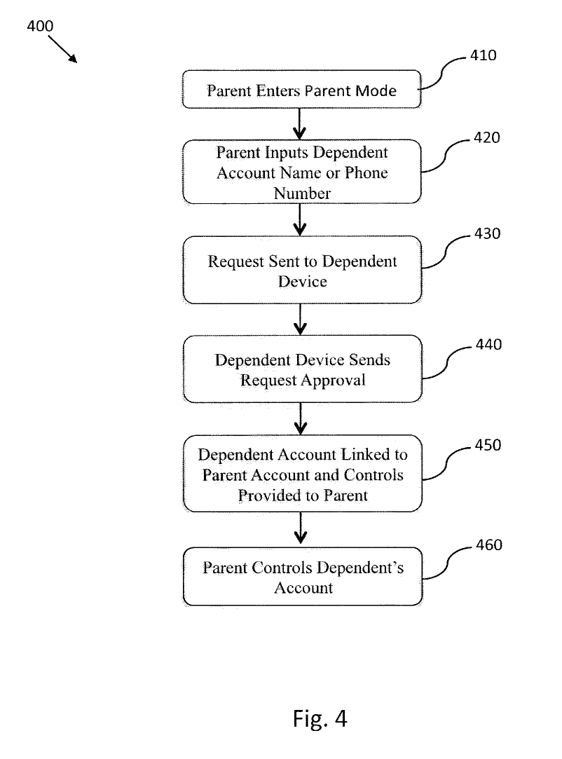

FIG. 5 illustrates a method 500 of a parent purchasing digital assets and transferring the digital assets to a dependent in the form of a digital card according to some embodiments of the present technology. The method 500 involves a parent obtaining digital assets from a partner that utilizes a digital wallet application 510. For example, a parent can buy movie tickets from an online movie ticket re-seller who has a digital card application. Next, when purchasing the tickets, the parent can chose to have the assets delivered to the dependent's digital wallet application in the form of a digital card with an optical code used to redeem the assets 520. For example, in some embodiments, the digital card can include a barcode or QR code that can be scanned at the movie theatre. In some embodiments, the digital card can use the NFC capabilities of the user's electronic device to redeem assets.

Next, the digital card is delivered to the parent device 530 by the movie ticket re-seller, the parent selects to have the assets delivered to a digital wallet application on a dependent's device 540, and the digital card is transferred 545. As explained above, in some embodiments of the present technology, the transfer of the digital card between the parent and dependent is performed in a network-based storage platform, such as ICLOUD. Using a cloud-based storage solution allows the digital card to be redeemed by the dependent device and easily monitored and managed by the parent device. Indeed, the method 500 involves both the parent entering parent mode 560 and tracking/managing the assets 580 and the dependent using the assets 550. In some embodiments, a notification is sent 570 to the parent device upon the dependent's use of the assets informing the parent that the assets have been redeemed.

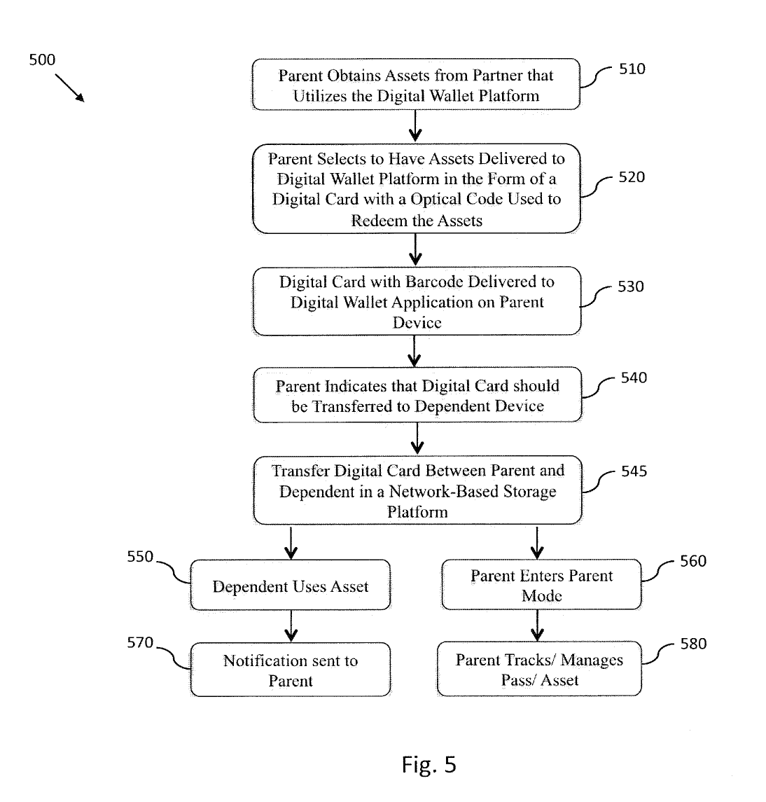

According to some embodiments of the present technology, a parent can monitor and manage digital cards and assets that have previously been transferred to a dependent or that the dependent otherwise obtained in a digital card platform. FIG. 6 illustrates an exemplary method 600 of a parent monitoring a dependent's digital assets. First, the parent enters Parent Mode in a digital wallet application or media distribution platform 610, accesses a Parent Mode interface, and receives a list of dependents 615. With the interface, the parent can view and navigate a list of digital cards and assets associated with the digital cards 620. For example, the interface can list all of a dependents gift cards and ticket redemption cards along with a listing of the balance on the gift card and a status relating to whether the ticket redemption cards have been redeemed.

The method 600 also involves a parent purchasing additional assets to bolster the balance of a dependent's digital card 630. In some embodiments of the present technology, a media distribution platform can be used to purchase additional assets and the assets can be delivered via a network-based storage platform tied to the media distribution platform. For example, in some embodiments, an ITUNES account can be used to purchase additional assets and the assets can be delivered via an ICLOUD account tied to the ITUNES account. Accordingly, the method 600 involves the parent requesting the use of media distribution platform to complete a purchase for additional assets 640, the media distribution platform requesting authentication 650, processing a purchase 660, delivering a notification regarding the purchase 665, and transferring the newly-purchased assets to the dependent device via a network-based storage platform 670.

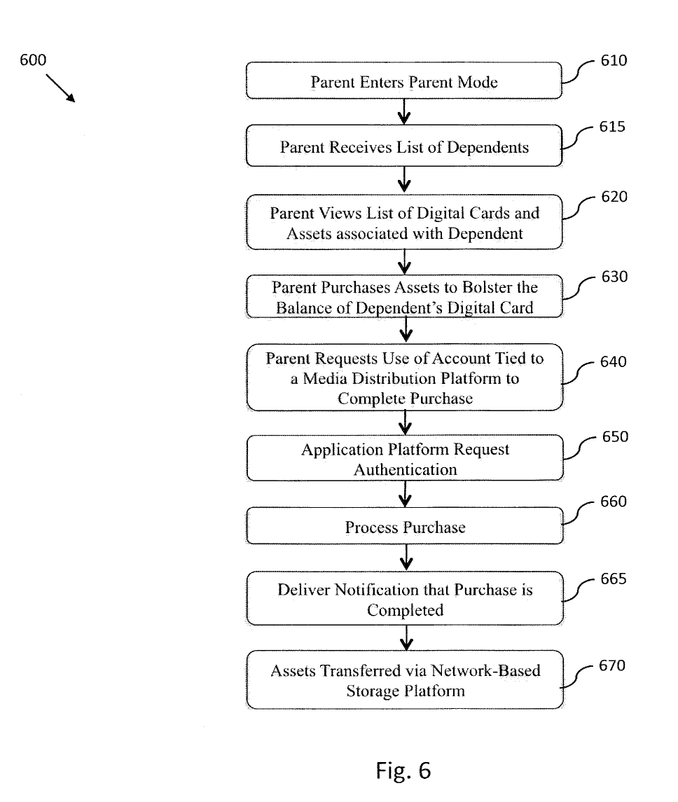

As explained above, some embodiments of the present technology involve turning on a Parent Mode through a digital wallet application settings interface in a settings menu of a network-based storage platform. FIG. 7 illustrates an exemplary activity-tracking interface 700. FIG. 7 shows a digital wallet application settings interface 710 in a settings menu 715 of a network-based storage platform. The digital wallet application settings interface 710 includes a button 720 which turns Parent Mode on and off. In some embodiments, turning Parent Mode on causes the device to display another intermediate interface 725 that allows a parent to add a new dependent or manage existing dependents. Selecting to manage an existing dependent can cause the device to display a dependent wallet interface 730 that lists all of the dependent's digital cards and other information such as card balance, train number, flight number, etc.

In some embodiments, selecting an individual card 734 in a digital wallet interface 733 causes the device to display a parent management interface 735 for a particular digital card 734 in the digital wallet interface 733. The parent management interface 735 can display a button 740 for adding value to the card, a button 745 for removing assets or removing the entire card, a button 760 for viewing card activity, and a button 750 for placing restrictions on the card. Viewing card activity can include viewing when, where, and how much of a card balance is being used by the dependent. In some embodiments, a map of card activity can be displayed. Examples of restrictions monetary amount restrictions, temporal restrictions, content rating restrictions, geographical restrictions, etc.

In addition to managing digital cards and digital assets for dependents, some embodiments of the present technology involve notifying a parent or a child about events relating to digital card transfers and other activities. As explained above, the digital wallet platform can create a link between user accounts and between network-based storage platform accounts. Consequently, when an event occurs that affects a digital card saved in a network-based storage platform, the instance of that event can be easily recognized by any account linked to the digital card. As such, the present technology allows notifications to be easily directed to relevant parties.

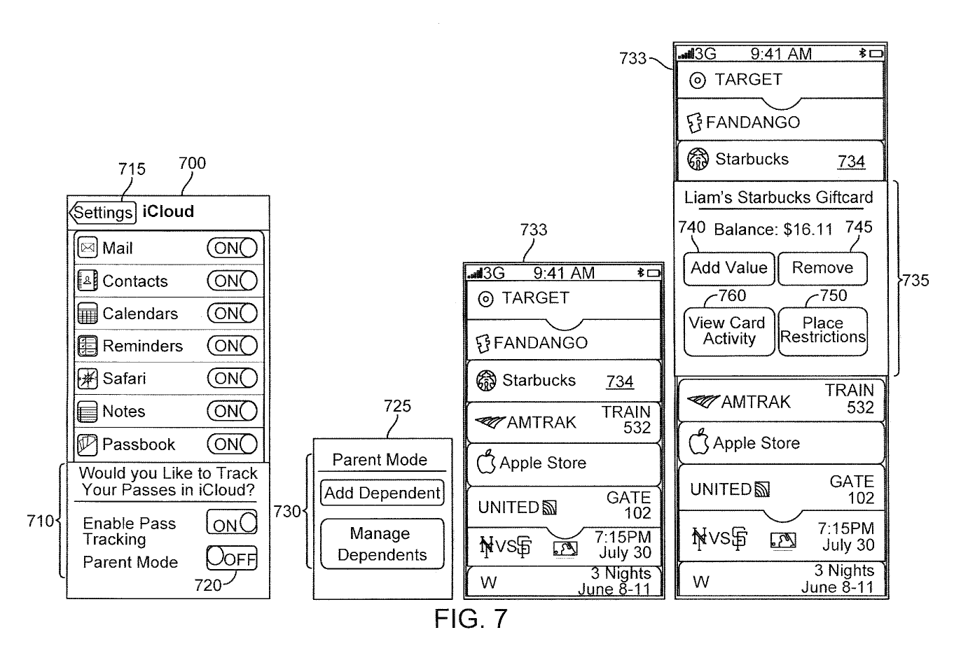

FIG. 8 illustrates an exemplary event notification directed to a parent running a parent mode in a digital wallet application. FIG. 8 shows an electronic device 800 in a locked state having an unlock tool 810 and a notification overlay 820 that is accessible upon unlocking the device 800. The notification overlay 820 comprises an alert 822 and option buttons 824, 826, 828. The alert 822 notifies the parent that a dependent's digital card balance is low, button 824 is configured to direct the parent to a screen for adding value to the digital card, button 828 is configured to direct the parent to a digital card management interface, and button 826 is configured to allow the parent to ignore the notification.

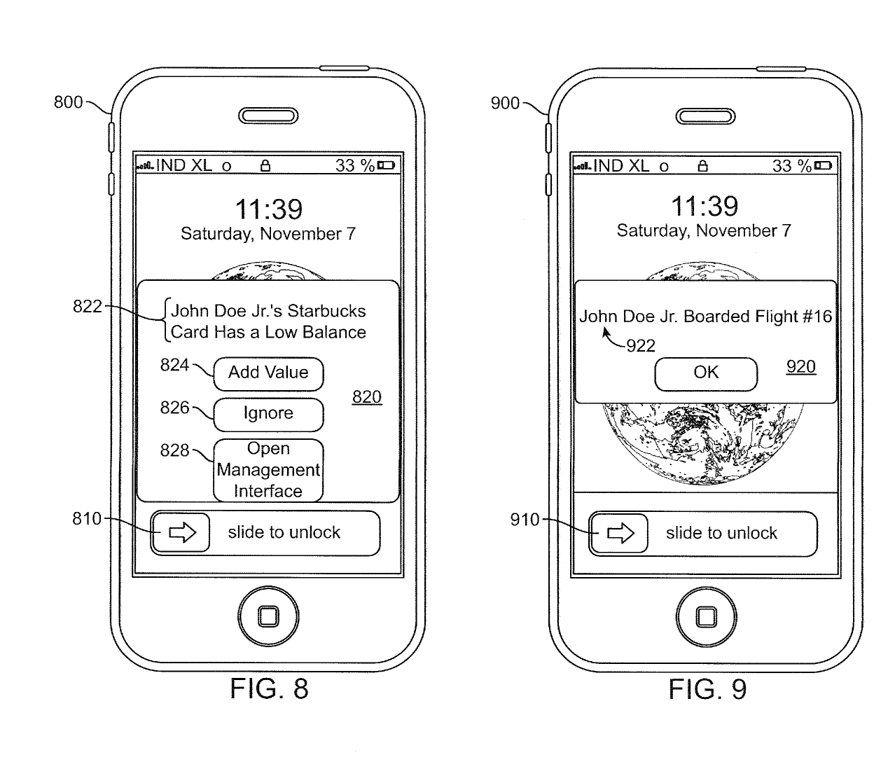

FIG. 9 illustrates an exemplary event notification directed to a parent running a parent mode in a digital wallet application. FIG. 9 shows an electronic device 900 in a locked state having an unlock tool 910 and a notification overlay 920 that is accessible upon unlocking the device 900. The notification overlay 920 comprises an alert 922 notifying the parent that a dependent redeemed an airline pass and boarded a flight.

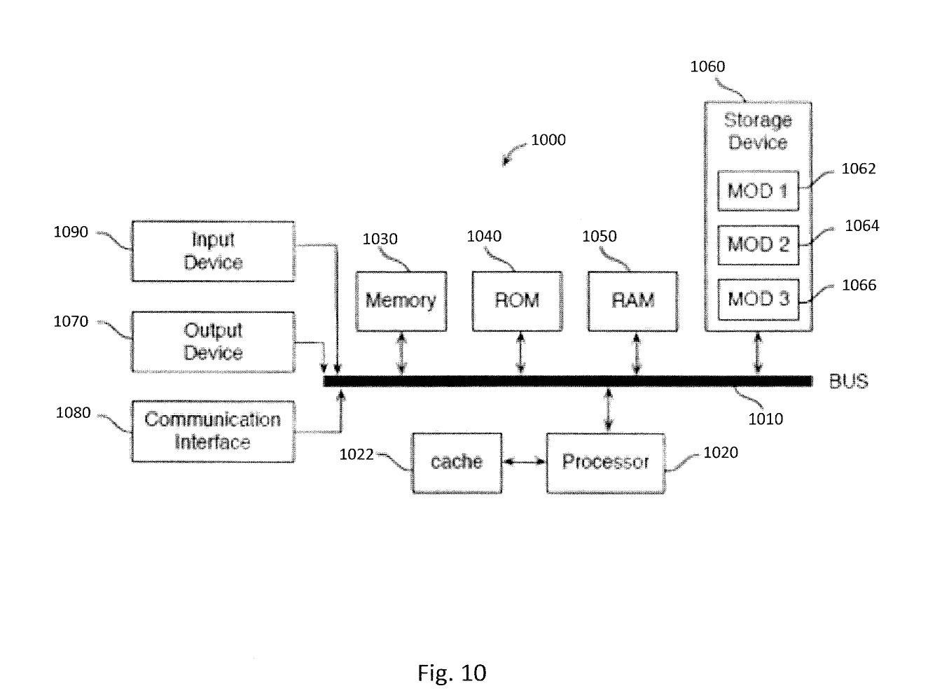

With reference to FIG. 10, an exemplary system 1000 includes a general-purpose computing device 1000, including a processing unit (CPU or processor) 1020 and a system bus 1010 that couples various system components including the system memory 1030 such as read only memory (ROM) 1040 and random access memory (RAM) 1050 to the processor 1020. The system 1000 can include a cache 1022 connected directly with, in close proximity to, or integrated as part of the processor 1020. The system 1000 copies data from the memory 1030 and/or the storage device 1060 to the cache for quick access by the processor 1020. In this way, the cache provides a performance boost that avoids processor 1020 delays while waiting for data. These and other modules can control or be configured to control the processor 1020 to perform various actions. Other system memory 1030 may be available for use as well. The memory 1030 can include multiple different types of memory with different performance characteristics. It can be appreciated that the disclosure may operate on a computing device 1000 with more than one processor 1020 or on a group or cluster of computing devices networked together to provide greater processing capability. The processor 1020 can include any general purpose processor and a hardware module or software module, such as module 1 1062, module 2 1064, and module 3 1066 stored in storage device 1060, configured to control the processor 1020 as well as a special-purpose processor where software instructions are incorporated into the actual processor design. The processor 1020 may essentially be a completely self-contained computing system, containing multiple cores or processors, a bus, memory controller, cache, etc. A multi-core processor may be symmetric or asymmetric.

The system bus 1010 may be any of several types of bus structures including a memory bus or memory controller, a peripheral bus, and a local bus using any of a variety of bus architectures. A basic input/output (BIOS) stored in ROM 1040 or the like, may provide the basic routine that helps to transfer information between elements within the computing device 1000, such as during start-up. The computing device 1000 further includes storage devices 1060 such as a hard disk drive, a magnetic disk drive, an optical disk drive, tape drive or the like. The storage device 1060 can include software modules 1062, 1064, 1066 for controlling the processor 1020. Other hardware or software modules are contemplated. The storage device 1060 is connected to the system bus 1010 by a drive interface. The drives and the associated computer readable storage media provide nonvolatile storage of computer readable instructions, data structures, program modules and other data for the computing device 1000. In one aspect, a hardware module that performs a particular function includes the software component stored in a non-transitory computer-readable medium in connection with the necessary hardware components, such as the processor 1020, bus 1010, display 1070, and so forth, to carry out the function. The basic components are known to those of skill in the art and appropriate variations are contemplated depending on the type of device, such as whether the device 1000 is a small, handheld computing device, a desktop computer, or a computer server.

Although the exemplary embodiment described herein employs the hard disk 1060, it should be appreciated by those skilled in the art that other types of computer readable media which can store data that are accessible by a computer, such as magnetic cassettes, flash memory cards, digital versatile disks, cartridges, random access memories (RAMs) 1050, read only memory (ROM) 1040, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 1000, an input device 1090 represents any number of input mechanisms, such as a microphone for speech, a touch-sensitive screen for gesture or graphical input, keyboard, mouse, motion input, speech and so forth. An output device 1070 can also be one or more of a number of output mechanisms known to those of skill in the art. In some instances, multimodal systems enable a user to provide multiple types of input to communicate with the computing device 1000. The communications interface 1080 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 1020. The functions these blocks represent may be provided through the use of either shared or dedicated hardware, including, but not limited to, hardware capable of executing software and hardware, such as a processor 1020, that is purpose-built to operate as an equivalent to software executing on a general purpose processor. For example the functions of one or more processors presented in FIG. 10 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 1040 for storing software performing the operations discussed below, and random access memory (RAM) 1050 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 1000 shown in FIG. 10 can practice all or part of the recited methods, can be a part of the recited systems, and/or can operate according to instructions in the recited non-transitory computer-readable storage media. Such logical operations can be implemented as modules configured to control the processor 1020 to perform particular functions according to the programming of the module. For example, FIG. 10 illustrates three modules Mod1 1062, Mod2 1064 and Mod3 1066 which are modules configured to control the processor 1020. These modules may be stored on the storage device 1060 and loaded into RAM 1050 or memory 1030 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method comprising:
receiving a request from a first user to link the first user's digital wallet account with a second user's digital wallet account in a network-based storage platform and to obtain an aspect of control over the second user's digital wallet account;
forwarding the request to the second user;
receiving consent from the second user to link the second user's account with the first user's account and to surrender an aspect of control over the second user's digital wallet account; and
linking the second user's digital wallet account with the first user's digital wallet account in the network-based storage platform.

2. The method of claim 1, further comprising:
creating a shared workspace in the network-based storage platform accessible by the first user and the second user upon the second user's digital wallet account being linked with the first user's digital wallet account.

3. The method of claim 2, wherein the shared workspace is configured for storing an object that can be accessed by the first user and the second user.

4. The method of claim 3, further comprising pushing a link to the object to the second user's digital wallet account from the shared workspace.

5. The method of claim 4, wherein the object comprises a digital card linked with a financial account and containing a code configured to redeem an asset.

6. The method of claim 2, wherein the shared workspace is configured for storing assets redeemable via a digital card stored on an electronic device of the second user.

7. The method of claim 1, further comprising:
creating a management interface accessible by the first user through the first user's digital wallet account upon the second user's digital wallet account being linked with the first user's digital wallet account, wherein the management interface comprises tools for managing the second user's digital wallet account.

8. The method of claim 1, further comprising:
memorializing the link between the second user's digital wallet account and the first user's digital wallet account in a media distribution platform client application of the first user; and
creating a management interface in the first user's media distribution platform client application, the management interface comprising tools for managing the second user's digital wallet account.

9. The method of claim 1, further comprising:
updating the first user's digital wallet application to reflect changes in the second user's digital wallet account.

10. The method of claim 9, wherein updating the first user's digital wallet application comprises pushing notifications from the network-based storage platform to an electronic device of the first user.

11. The method of claim 1, further comprising pushing notifications relating to the request from the network-based storage platform to an electronic device of the second user.

12. A system comprising:
a digital wallet processing engine operatively coupled with an account database and a network-based storage platform, wherein the digital wallet processing engine is configured to:
receive a request from a first electronic device associated with a first account stored in the account database to link the first account with a second account and to obtain an aspect of control over the second account;
forward the request to a second electronic device associated with the second account;
receive consent from the second electronic device to link the second account with the first account and surrender an aspect of control over the second account; and
link the second user's digital wallet account with the first user's digital wallet account in the network-based storage platform.

13. The system of claim 12, wherein the network-based storage platform comprises a shared workspace in the accessible by the first user and the second user upon the second account being linked with the first account, wherein the shared workspace is configured for storing digital assets and digital cards having a code configured for redeeming digital assets.

14. The system of claim 13, wherein the digital wallet processing engine is further configured to push a link to a digital card to the second account from the shared workspace upon receiving a transfer instruction from the first account.

15. The system of claim 12, further comprising:
a management interface accessible by the first electronic device upon the second account being linked with the first account, wherein the management interface comprises tools for managing the second user's digital wallet account.

16. The system of claim 12, further comprising:
a media distribution platform client application operating on the first electronic device, wherein the digital wallet processing engine is further configured to:
memorialize the link between the second account and the first account in a media distribution platform client application of the first user; and
create a management interface in the media distribution platform client application comprising tools for managing the second user's digital wallet account.

17. The system of claim 12, wherein the digital wallet processing engine is further configured to update the first account to reflect changes in the second account.

18. The system of claim 17, wherein the digital wallet processing engine is further configured to update the first account in the form of pushing notifications from the network-based storage platform to an electronic device of the first user.

19. The system of claim 17, wherein the digital wallet processing engine is further configured to push notifications relating to the request from the network-based storage platform to an electronic device of the second user.

20. A non-transitory computer-readable medium comprising:
a medium configured to store computer-readable instructions thereon; and
the computer-readable instructions that, when executed by a processing device cause the processing device to perform a method, comprising:
receiving a request from a first user to link the first user's digital wallet account with a second user's digital wallet account in a network-based storage platform and to obtain an aspect of control over the second user's digital wallet account;
forwarding the request to the second user;
receiving consent from the second user to link the second user's account with the first user's account and to surrender an aspect of control over the second user's digital wallet account;
linking the second user's digital wallet account with the first user's digital wallet account in the network-based storage platform;
creating a shared workspace in the network-based storage platform accessible by the first user and the second user upon the second user's digital wallet account being linked with the first user's digital wallet account;
creating a management interface accessible by the first user through the first user's digital wallet account upon the second user's digital wallet account being linked with the first user's digital wallet account, wherein the management interface comprises tools for managing the second user's digital wallet account; and
updating the first user's digital wallet application to reflect changes in the second user's digital wallet account.
